(19) United States
(12) Patent Application Publication
(10) Pub. No.: US 2019/0056642 A1
(43) Pub. Date: Feb. 21, 2019

(54) MICROSCOPE OCULAR LENS CAMERA ADAPTOR

(71) Applicant: Elliot Weinthal, Oviedo, FL (US)

(72) Inventor: Elliot Weinthal, Oviedo, FL (US)

(21) Appl. No.: 16/104,669

(22) Filed: Aug. 17, 2018

Related U.S. Application Data
(60) Provisional application No. 62/547,438, filed on Aug. 18, 2017.

(51) Int. Cl. G03B 17/48; G02B 21/36

(52) U.S. Cl. CPC G03B 17/48; G02B 25/001; G02B 21/362

(57) ABSTRACT

A microscope adaptor device includes an elongated generally cylindrical-shaped main body having an open first end and a closed second end that define a hollow interior space. The main body includes a shape and size that is complementary to the known shape and size of a microscope so as to receive an eyepiece of a microscope within the hollow interior space. A centrally located aperture is positioned within the second end of the main body in a linear orientation with an ocular lens of the microscope eyepiece positioned within the interior space.

### CROSS-REFERENCE TO RELATED APPLICATIONS

This application claims the benefit of U.S. application Ser. No. 62/547,438 filed on Aug. 18, 2017, the contents of which are incorporated herein by reference.

### TECHNICAL FIELD

The present invention relates generally to camera adaptors, and more particularly to a camera adaptor for capturing high quality images from the ocular lens of a microscope.

### BACKGROUND

The statements in this section merely provide background information related to the present disclosure and may not constitute prior art.

Students and professionals utilizing microscopes must often document their observations. To this end, there are a number of commercially available microscope camera systems that are designed to independently capture the image(s) that are concurrently shown through the ocular lens of a microscope. The captured images can be saved on the camera system so as to be available for later analysis. Owing to the differences in microscope design and optics, such camera systems are typically custom-built devices that can be utilized only for a single type or series of microscope.

Because the cost of each camera system is extremely high, such systems are only designed to be used with extremely high-end microscopes such as those found at research laboratories. Indeed, each custom camera system typically includes a housing that is custom fit for a particular type or model of microscope and permanently secured thereto. Within the camera housing, any number of camera systems are provided for capturing and/or remotely viewing the contents of the microscope on external monitors, for example.

Although such devices are useful, their specificity to a particular microscope and high costs make it difficult for schools and universities to employ en masse. Rather than reserving and waiting for an available time to use a microscope that is equipped with an expensive image capture system, many users are increasingly attempting to utilize their smartphone camera to take a picture of a microscope slide through one of the ocular lenses.

Unfortunately, because the ocular lens of a microscope is designed for direct viewing by a human eye, it is extremely difficult to obtain clear images using such a procedure. Moreover, it is difficult for users to position and hold the smartphone camera at the exact, specified distance required to capture a clear image. This problem is exacerbated by the inherent autofocus features of many modern cell phone cameras.

Accordingly, it would be beneficial to provide an adaptor device that can be connected to the ocular lens of a microscope to allow a user to capture clear images using a smartphone camera or other such device.

### SUMMARY OF THE INVENTION

The present invention is directed to a microscope adaptor device. One embodiment of the present invention can include an elongated, generally cylindrical-shaped main body having an open first end, and a closed second end that define a hollow interior space. The main body can include a shape and size that is suitable for receiving an eyepiece of a microscope within the hollow interior space. A centrally located aperture can be positioned within the second end of the main body. The aperture can be positioned in a linear orientation with an ocular lens that is located on the eyepiece of the microscope positioned within the interior space. The length of the aperture can be determined based on a thickness of the closed second end, and the thickness can be based on a type of lens used by the microscope.

In one embodiment, the device can be constructed so as to include a specific shape, size and dimension that corresponds to the known shape, size, dimensions and lenses used by a microscope to which the device is designed to be used with.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of a microscope adaptor device that is useful for understanding the inventive concepts disclosed herein.

FIG. 2 is a bottom perspective view of the microscope adaptor device, in accordance with one embodiment of the invention.

FIG. 3 is a top view of the microscope adaptor device in operation, in accordance with one embodiment of the invention.

FIG. 4 is a side view of the microscope adaptor device in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

As described herein, the term “removably secured” and derivatives thereof shall be used to describe a situation wherein two or more objects are joined together in a non-permanent manner so as to allow the same objects to be repeatedly joined and separated.

As described throughout this document, the term “complementary shape,” and “complementary dimension,” shall be used to describe a shape and size of a component that is identical to, or substantially identical to the shape and size of another identified component.

Although illustrated for use with a smartphone camera, the inventive concepts are not so limiting. To this end, the device can be utilized with any type of handheld camera or other form of image capture device.

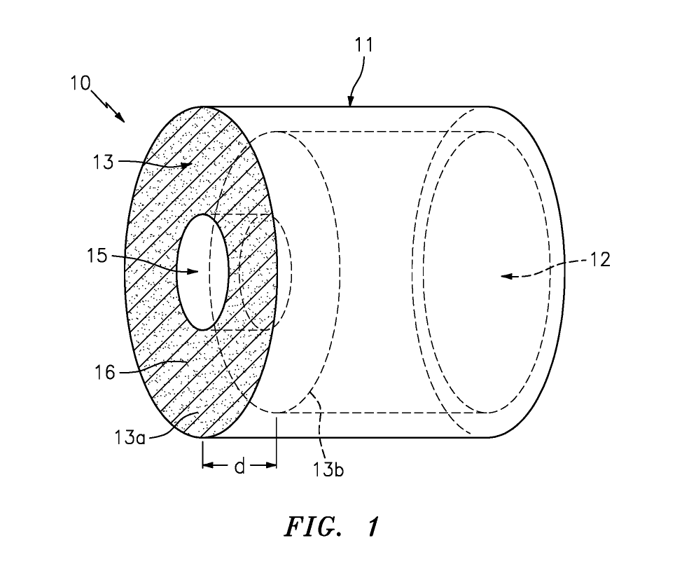

FIGS. 1-4 illustrate one embodiment of a microscope adaptor device 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure.

As will be described below, the microscope adaptor 10 can provide an ultra-low-cost alternative to integrated microscope cameras that directly engages the eyepiece of a microscope and provides a user with the ability to photograph the image displayed by the ocular lens itself using their smartphone camera.

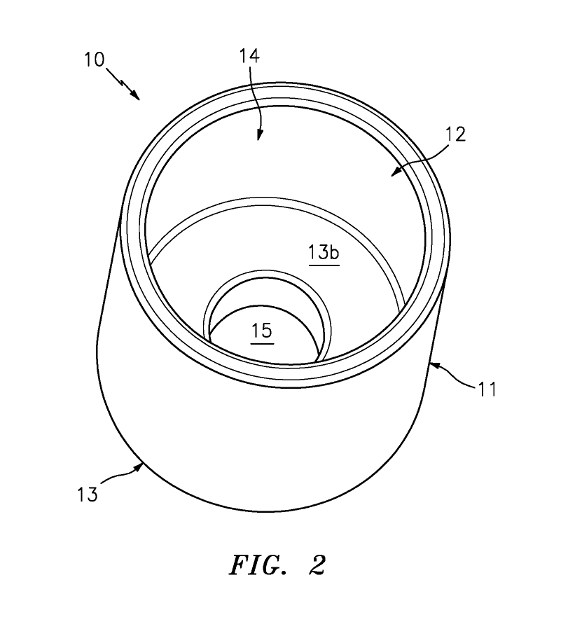

As shown best in FIGS. 1 and 2, one embodiment of the device 10 can include an elongated, generally cylindrical-shaped main body 11 having an open first end 12, and a closed second end 13 that define a generally hollow interior space 14. A centrally located aperture 15 can be provided along the closed end and can extend from the outside facing surface 13a to the inside facing surface 13b.

In various embodiments, the central aperture can include a beveled outer edge so as to aid a user in lining up the camera of a smartphone device with the aperture. Additionally, various embodiments can include a resilient high friction material 16 such as rubber, for example, that is positioned along a portion or an entirety of the outside facing surface 13b. Such a material advantageously provides a soft surface for making contact with the back side of a user's smartphone, while simultaneously preventing the phone from shifting/sliding during use and inadvertently misaligning the phone camera with the aperture.

In the preferred embodiment, the device 10 will be constructed from a single piece of material that is relatively strong and stiff for its weight. Several nonlimiting examples include but are not limited to various plastic/polymers (e.g., high-density polyethylene (HDPE) or polyethylene terephthalate (PET)), and/or various composite materials (e.g., carbon fibers in a polymer matrix, fiberglass, etc.). Of course, any number of other materials are also contemplated.

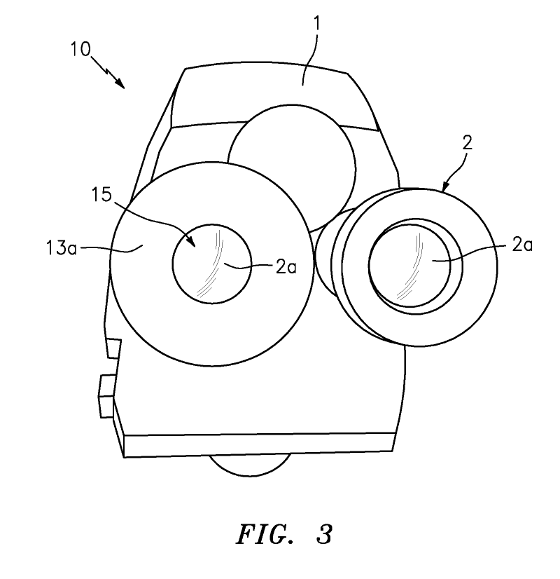

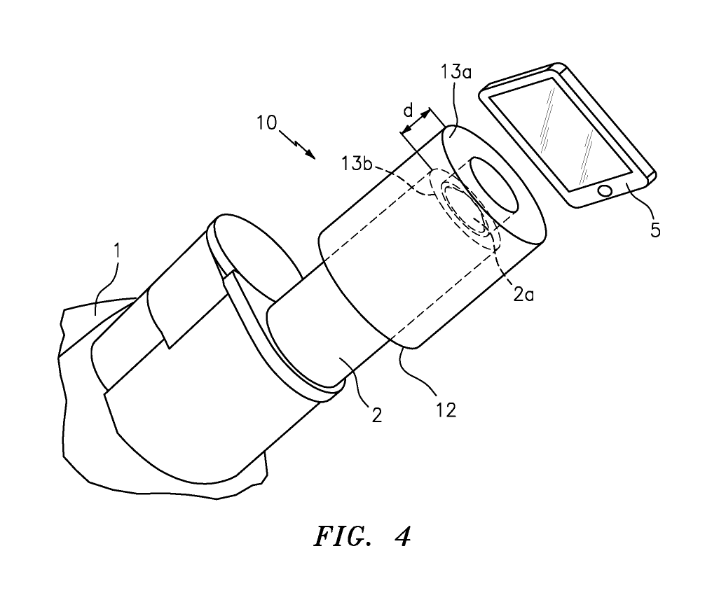

FIGS. 3 and 4 illustrate one embodiment of the device 10 in operation. As shown, the main body 11 is configured to receive one eyepiece 2 of a microscope 1 whereby the eyepiece is positioned through the open end 12 and secured within the hollow interior space 14 until the distal end of the eyepiece makes contact with the inside surface 13b. When so positioned, the central aperture 15 will be positioned in a linear orientation with the ocular viewing lens 2a located on the eyepiece and will form a photo channel through which the camera of a smartphone 5 can photograph the contents displayed by the lens 2a.

Owing to design differences between various types of microscopes and/or microscope manufacturers, each adaptor device 10 will preferably be manufactured to include dimensions that are specific to a particular make, model, or type of microscope. To this end, the main body 11 will include an inside diameter that is complementary to or slightly greater than (e.g., 5 mm-15 mm) the known outside diameter of the eyepiece 2 of the microscope to which the device 10 is designed to be used.

Likewise, smartphone cameras have varying levels of image resolution capability, and microscopes are manufactured with a plurality of different lenses which affect what is shown by the ocular lens. In order for the smartphone camera to capture a clear image of what is shown on the ocular lens, it is necessary for the camera to be positioned an optimal distance away from the lens.

As described herein, the optimal distance is the distance whereby an eight-megapixel digital camera that is positioned against the outside surface of the main body 13b is able to capture a clear and distortion free/non-fuzzy image of what is shown on the ocular lens 2a of a microscope eyepiece 2 that is positioned within the main body. Eight megapixels being the minimum resolution found on virtually all modern smartphone cameras.

In the preferred embodiment, this optimal distance can be represented by the separation distance d between the inside facing surface 13a and outside facing surface 13b, and can be calculated for a particular microscope using the following equations:

1/s+1/s′=1/f (Thin Lens Equation)→f is focal length, s is distance to object and s′ is distance to image.

Microscopes will use multiple lenses so the image of one will become the object of the next, so you will have to use this equation twice.

M=h_{O}/h_{I} where ho is the height of the object and hi is the height of the image. When calculating the final image size, you will have h₂=m₁m₂h₁ where m₁ and m₂ are the magnification factors for the two lenses and h₁ is the object height, and h₂ is the final image height. So total magnification is the product of the magnification factors.

By way of example, one nonlimiting embodiment of the device 10 can include a length (e.g., distance between first end 12 and second end 13) of 58 mm; a hollow inside diameter of 44 mm; an inside length (distance between inside facing surface 13b and the open first end 12) of 38 mm; and an optimal photo channel distance d of 20 mm. Such dimensions being suited for use with a model DM 500/750 LED biological microscope that is commercially available from Leica Microsystems.

Accordingly, the above described microscope adaptor device provides a low-cost alternative to integrated camera systems that can be mass produced for use with any type, brand or model of microscope so as to allow a user to capture images using their smartphone camera.

Although the above embodiments have been described as including a unitary construction, the inventive concepts disclosed herein are not so limiting. To this end, one of skill in the art will recognize that one or more individually identified elements may be formed as separate components that are formed together through manufacturing processes, such as welding, casting, or molding, or through the use of multiple pieces of material that are milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the terms “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A microscope adaptor device, comprising:
an elongated main body having a closed end, an open end and a hollow interior space,
said closed end including an outside facing surface and an inside facing surface that are separated by a first distance;
an aperture that is positioned on the closed end of the main body and extends from the outside facing surface to the inside facing surface,
wherein the hollow interior space is configured to receive an eyepiece of a microscope, and to position the aperture in line with an ocular viewing lens of the eyepiece of the microscope.

2. The device of claim 1, wherein the open first end and the hollow interior space include an inside dimension that is complementary to a known outside dimension of the eyepiece of the microscope.

3. The device of claim 1, wherein the first distance is determined at a time of manufacture based on a type of lens within the eyepiece of the microscope.

4. The device of claim 1, wherein the device is constructed from a single piece of plastic includes a shape and size that is suitable for a specific type of microscope.

5. The device of claim 1, wherein the device is constructed from a single piece of plastic includes a shape and size that is designed to be used with a specific brand of microscope.
